(19) United States
(12) Patent Application Publication
(10) Pub. No.: US 2024/0154437 A1
(43) Pub. Date: May 9, 2024

(54) Battery Charging Device

(71) Applicant: Isaac James, Houston, TX (US)

(72) Inventor: Isaac James, Houston, TX (US)

(21) Appl. No.: 17/982,160

(22) Filed: Nov. 7, 2022

(51) Int. Cl. H02J 7/00; H02G 11/02

(52) U.S. Cl. CPC H02J 7/0045; H02G 11/02

(57) ABSTRACT

A battery charging device for charging a battery of a mobile device includes a housing having a first side wall, a second side wall, a top wall, a bottom wall, a front wall, and a back wall. The bottom wall has an opening extending therein. A spool is rotatably coupled to the first side wall within the interior space and a charging cord is wound about the spool and extends outwardly through the opening. The charging cord has a first end and second end. A power supply is positioned within the interior space and is electrically coupled to the second end of the charging cord. A universal serial bus plug is pivotally coupled to the top wall and is electrically coupled to the power supply. An outlet plug is pivotally coupled to the front wall of the housing and is electrically coupled to the power supply.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electric charging cables and more particularly pertains to a new electric charging cable for charging a battery of a mobile device.

### (2) Description of Related Art Including Information Disclosed Under 37 CFR 1.97 and 1.98

The prior art relates to electric charging cables and includes a variety of electric charging cables being wrapped about a spool and receiving electricity from an outlet plug. Furthermore, known prior art relates to a variety of electric charging cables receiving electricity from a universal serial bus plug. Known prior art does not allow an electric charging cable to receive electricity from an outlet plug and a universal serial bus plug.

### BRIEF SUMMARY OF THE INVENTION

An embodiment of the disclosure meets the needs presented above by generally comprising a housing having a first side wall, a second side wall, a top wall, a bottom wall, a front wall, and a back wall. The housing encloses an interior space and the bottom wall has an opening extending therein. A spool is rotatably coupled to the first side wall within the interior space. A charging cord is wound about the spool and extends outwardly through the opening. The charging cord has a first end and second end wherein the second end is positioned within the housing. A power supply is positioned within the interior space and is electrically coupled to the second end of the charging cord. A universal serial bus plug is pivotally coupled to the top wall and is electrically coupled to the power supply. An outlet plug is pivotally coupled to the front wall of the housing and is electrically coupled to the power supply. A retraction inhibitor is mounted to the housing and is in mechanical communication with the spool to control rotation of the spool relative to the housing. A reel is rotatably mounted on the housing and is engaged with the spool, wherein the spool is rotated when the reel is rotated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a battery charging device according to an embodiment of the disclosure.

FIG. 2 is a front view of an embodiment of the disclosure.

FIG. 3 is a back view of an embodiment of the disclosure.

FIG. 4 is an in-use view of an embodiment of the disclosure.

FIG. 5 is a side view of an embodiment of the disclosure.

FIG. 6 is a cross-sectional view of an embodiment of the disclosure taken along Line 6-6 from FIG. 5.

FIG. 7 is a cross-sectional view of an embodiment of the disclosure taken along Line 7-7 from FIG. 5.

### DETAILED DESCRIPTION OF THE INVENTION

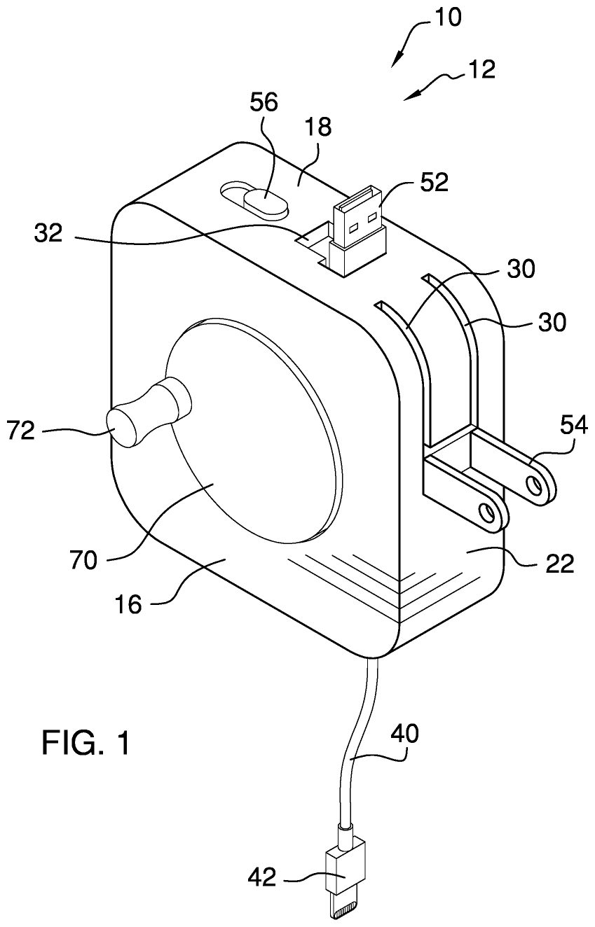

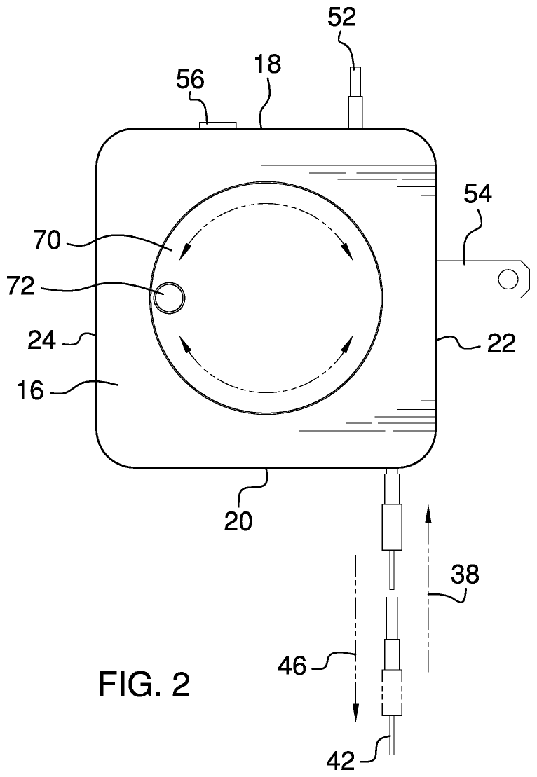

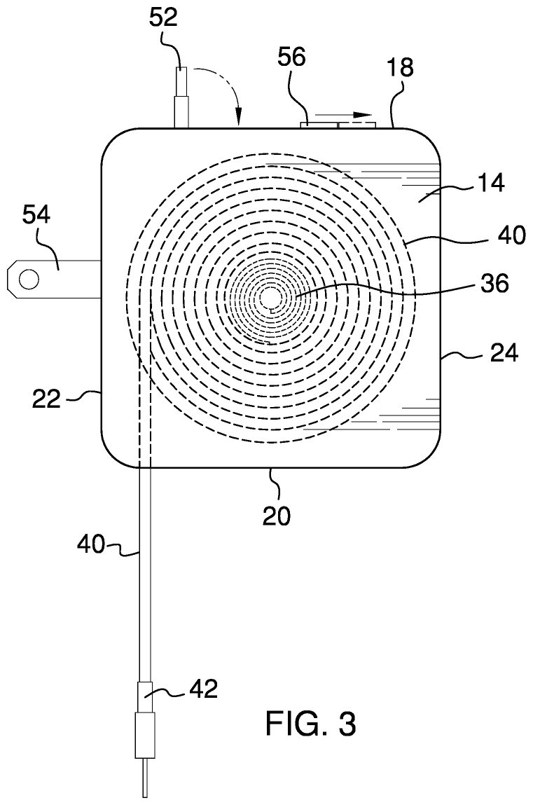

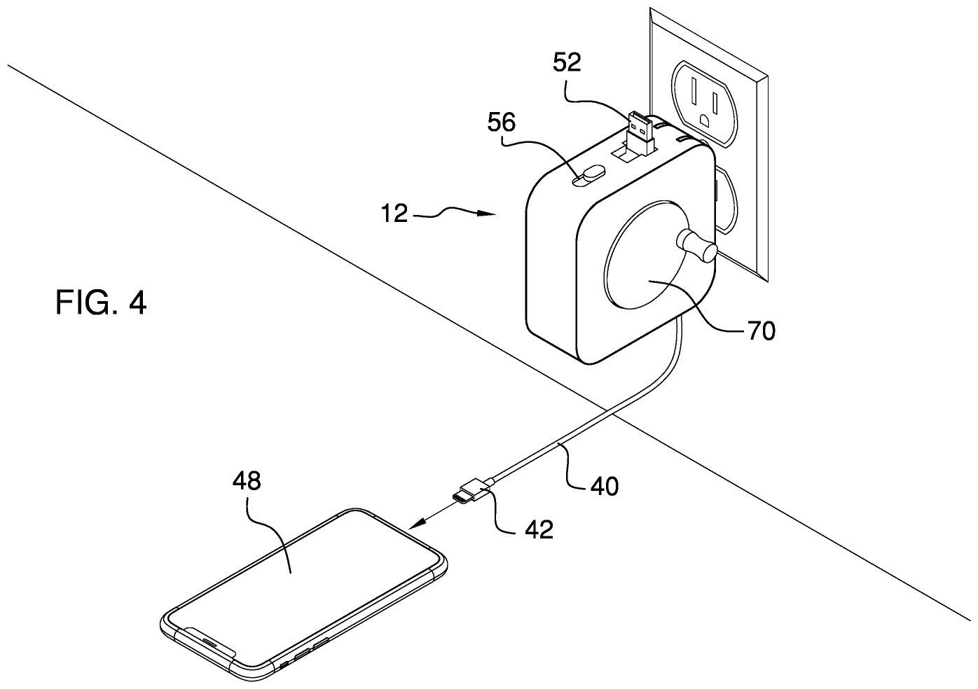

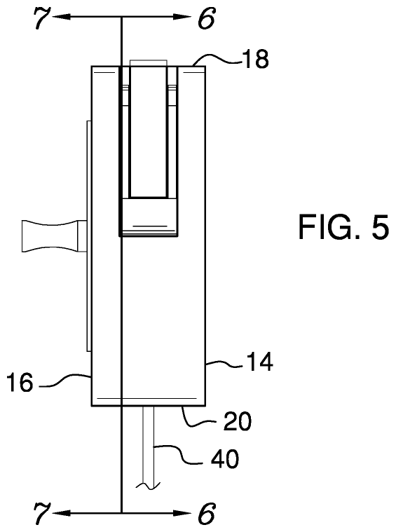

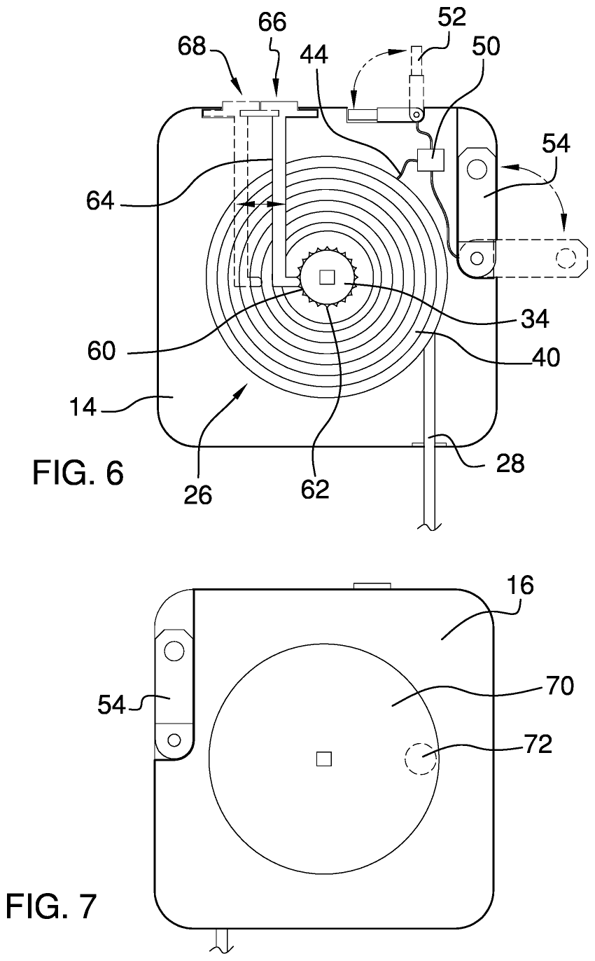

With reference now to the drawings, and in particular to FIGS. 1 through 7 thereof, a new electric charging cable embodying the principles and concepts of an embodiment of the disclosure and generally designated by the reference numeral 10 will be described.

As best illustrated in FIGS. 1 through 7, the battery charging device 10 generally comprises a housing 12 having a first side wall 14, a second side wall 16, a top wall 18, a bottom wall 20, a front wall 22, and a back wall 24. The housing 12 encloses an interior space 26 and the bottom wall 20 has an opening 28 extending therein. The front wall 22 has a pair of slots 30 extending therethrough and the top wall 18 has a cavity 32 extending therethrough.

A spool 34 is rotatably coupled to the first side wall 14 within the interior space 26. A retractable mechanism 36 is positioned within the housing 12 and is mechanically coupled to the spool 34 to bias rotation of the spool 34 in a first direction 38. The retractable mechanism 36 may comprise a spring. A charging cord 40 is wound about the spool 34 and extends outwardly through the opening 28. The charging cord 40 has a first end 42 and second end 44 wherein the second end 44 is positioned within the housing 12. The spool 34 is rotated in a second direction 46 to extend the charging cord outwardly of the housing 12 and the charging cord 40 is drawn into the housing 12 when the spool 34 rotates in the first direction 38. The first end 42 will typically comprise a male plug for a mobile device 48.

A power supply 50 is positioned within the interior space 26 and is electrically coupled to the second end 44 of the charging cord 40. The power supply 50 normally comprises an electric converter. A universal serial bus plug 52 is pivotally coupled to the top wall 18 and is electrically coupled to the power supply 50. The universal serial bus plug 52 is removably stored in the cavity 32 of the top wall 18 and is configured for being inserted into a universal serial bus port of an electrical power source. An outlet plug 54 is pivotally coupled to the front wall 22 of the housing 12 and is electrically coupled to the power supply 50. The outlet plug 54 may comprise a pair of prongs being pivotally coupled to the housing 12 such that the prongs are removably stored within the slots 30 of the front wall 22.

A retraction inhibitor 56 is mounted to the housing 12 and is in mechanical communication with the spool 34 to control rotation of the spool 34 relative to the housing 12. The retraction inhibitor 56 may include a disc 58 mounted on the spool 34 and having a perimeter edge 60. The perimeter edge 60 may have a plurality of teeth 62 and the disc 58 is normally axially aligned with the spool 34. A lock 64 is mounted on the housing 12 and is positionable in a first position 66 to engage the disc 58 and inhibit rotation of the spool 34 or in a second position 68 to disengage from the disc 58. The lock 64 normally includes an actuator being slidably mounted on the top wall 18 and a lever attached to the actuator. The lever is positioned for selective engagement with one of the teeth 62.

A reel 70 is rotatably mounted on the housing 12 and is engaged with the spool 34 wherein the spool 34 is rotated when the reel 70 is rotated. The reel 70 is positioned on the second side wall 16 and typically includes a grip 72 extending away from the second side wall 16.

In use, the outlet plug 54 is inserted into a receptacle of an electrical power source or the universal serial bus plug 52 is inserted into a universal serial bus port of an electrical power source to provide electricity to the power supply 50 of the housing 12. A charging port of a mobile device 48 can receive the male plug from the first end 42 of the charging cord 40 to recharge the battery of the mobile device 48. The charging cord can be extended out from the housing 12 by pulling on the first end 42 of the charging cord 40. The retraction inhibitor 56 can removably retain the first end 42 of the charging cord 40 in a fixed length relative to the opening 28 of the housing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile device charging device comprising:
a housing having a first side wall, a second side wall, a top wall, a bottom wall, a front wall, and a back wall, said housing enclosing an interior space, said bottom wall having an opening extending therein;
a spool being rotatably coupled to said first side wall within said interior space;
a charging cord being wound about said spool and extending outwardly through said opening, said charging cord having a first end and second end wherein said second end is positioned within said housing;
a power supply being positioned within said interior space and being electrically coupled to said second end of said charging cord;
a universal serial bus plug being pivotally coupled to said top wall and being electrically coupled to said power supply;
an outlet plug being pivotally coupled to said front wall of said housing and being electrically coupled to said power supply;
a retraction inhibitor being mounted to said housing and being in mechanical communication with said spool to control rotation of said spool relative to said housing; and
a reel being rotatably mounted on said housing and being engaged with said spool, wherein said spool is rotated when said reel is rotated.

2. The mobile device charging device of claim 1, wherein said front wall has a pair of slots extending therethrough, said top wall having a cavity extending therethrough.

3. The mobile device charging device of claim 1, further including a retractable mechanism being positioned within said housing and being mechanically coupled to said spool to bias rotation of said spool in a first direction, said retractable mechanism comprising a spring.

4. The mobile device charging device of claim 1, wherein said spool is rotated in a second direction to extend said charging cord outwardly of said housing and said charging cord is drawn into said housing when said spool rotates in said first direction, said first end comprising a male plug for a mobile device.

5. The mobile device charging device of claim 1, wherein said power supply comprises an electric converter.

6. The mobile device charging device of claim 2, wherein said universal serial bus plug is removably stored in said cavity of said top wall, said universal serial bus plug being configured for being inserted into a universal serial bus port of an electrical power source.

7. The mobile device charging device of claim 2, wherein said outlet plug comprises a pair of prongs, said prongs being pivotally coupled to said housing such that said prongs are removably stored within said slots of said front wall.

8. The mobile device charging device of claim 1, wherein said retraction inhibitor includes a disc being mounted on said spool and having a perimeter edge, said perimeter edge having a plurality of teeth, said disc being axially aligned with said spool.

9. The mobile device charging device of claim 8, further including a lock being mounted on said housing and being positionable in a first position engaging said disc and inhibiting rotation of said spool or in a second position disengaged from said disc, said lock including an actuator being slidably mounted on said top wall and a lever attached to said actuator, said lever being positioned for selective engagement with one of said teeth.

10. The mobile device charging device of claim 1, wherein said reel being positioned on said second side wall and including a grip extending away from said second side wall.

11. A mobile device charging device comprising:
a housing having a first side wall, a second side wall, a top wall, a bottom wall, a front wall, and a back wall, said housing enclosing an interior space, said bottom wall having an opening extending therein, said front wall having a pair of slots extending therethrough, said top wall having a cavity extending therethrough;
a spool being rotatably coupled to said first side wall within said interior space, a retractable mechanism being positioned within said housing and being mechanically coupled to said spool to bias rotation of said spool in a first direction, said retractable mechanism comprising a spring;
a charging cord being wound about said spool and extending outwardly through said opening, said charging cord having a first end and second end wherein said second end is positioned within said housing, said spool being rotated in a second direction to extend said charging cord outwardly of said housing and said charging cord being drawn into said housing when said spool rotates in said first direction, said first end comprising a male plug for a mobile device;
a power supply being positioned within said interior space and being electrically coupled to said second end of said charging cord, said power supply comprising an electric converter;
a universal serial bus plug being pivotally coupled to said top wall and being electrically coupled to said power supply, said universal serial bus plug being removably stored in said cavity of said top wall, said universal serial bus plug being configured for being inserted into a universal serial bus port of an electrical power source;
an outlet plug being pivotally coupled to said front wall of said housing and being electrically coupled to said power supply, said outlet plug comprising a pair of prongs, said prongs being pivotally coupled to said housing such that said prongs are removably stored within said slots of said front wall;
a retraction inhibitor being mounted to said housing and being in mechanical communication with said spool to control rotation of said spool relative to said housing, said retraction inhibitor including:
a disc being mounted on said spool and having a perimeter edge, said perimeter edge having a plurality of teeth, said disc being axially aligned with said spool;
a lock being mounted on said housing and being positionable in a first position engaging said disc and inhibiting rotation of said spool or in a second position disengaged from said disc, said lock including an actuator being slidably mounted on said top wall and a lever attached to said actuator, said lever being positioned for selective engagement with one of said teeth; and
a reel being rotatably mounted on said housing and being engaged with said spool, wherein said spool is rotated when said reel is rotated, said reel being positioned on said second side wall and including a grip extending away from said second side wall.
